(19) United States
(12) Patent Application Publication
(10) Pub. No.: US 2026/0233039 A1
(43) Pub. Date: Aug. 13, 2026

(54) MULTI-LEVEL GANTRY SYSTEMS FOR STOWING AND DEPLOYING ELONGATED OBJECTS SUCH AS HARD SLEEVES AND LADDERS

(71) Applicant: Ziamatic LLC, Yardley, PA (US)

(72) Inventors: Michael P. Ziaylek, Yardley, PA (US); Keith R. Creely, Levittown, PA (US); Morgan R. Sobel, Marlton, NJ (US); James Jarozynski, Collingswood, NJ (US)

(21) Appl. No.: 19/655,569

(22) Filed: Apr. 22, 2026

Related U.S. Application Data
(63) Continuation-in-part of application No. 19/186,705, filed on Apr. 23, 2025.
(60) Provisional application No. 63/637,814, filed on Apr. 23, 2024.

(51) Int. Cl. A62C 27/00; A62C 33/04; B60P 1/28; B60P 3/40

(52) U.S. Cl. CPC A62C 27/00; A62C 33/04; B60P 1/283; B60P 3/40

(57) ABSTRACT

A gantry system for stowing and deploying elongated objects such as hard sleeves and ladders includes a base assembly configured to be fixed to a mounting surface, a carriage assembly mounted on and configured to translate linearly in relation to the base assembly, and a forward support assembly mounted on the carriage assembly and configured to move in relation to the carriage assembly.

### CROSS-REFERENCE TO RELATED APPLICATIONS

This is a continuation-in-part of U.S. application Ser. No. 18/186,705, filed Apr. 23, 2025, which claims the benefit under 35 U.S.C. § 119(e) to U.S. provisional Application No. 63/637,814, filed Apr. 23, 2024. The contents of these applications are incorporated by reference herein in their entireties.

### BACKGROUND

Fire engines and other types of emergency vehicles typically carry the hoses and ladders needed to direct water from a water source and onto a fire during firefighting operations. For example, fire engines often carry hard suction hoses, or hard sleeves, that allow the fire engine to draw water from a static water source such as a portable water tank or a pool. As another example, fire engines often carry large extension ladders used by firefighters to gain access to the roof and above-ground floors of buildings during firefighting and rescue operations.

The hard sleeves or ladders may be stowed at or near the top of the fire engine due to space constraints. Thus, the first responder may need to climb onto the fire engine to retrieve the hard sleeves or ladders. The need to climb onto the fire engine can present significant disadvantages, including the potential for injury to the first responder caused by slipping, falling, or inadvertently contacting other equipment on the fire engine; and the potential delay in the commencement of firefighting operations. Also, offloading the hard sleeve from well above ground level may necessitate the use of a second person for the offloading process. These disadvantages can be heightened by the exigent nature of firefighting operations, and by the night and adverse weather conditions under which first responders often operate.

### SUMMARY

In one aspect of the disclosed technology, a gantry system for stowing and deploying an elongated object includes a base assembly configured to be fixed to a mounting surface, and a carriage assembly. The carriage assembly includes a first portion mounted on the base assembly and movable linearly in relation to the base assembly so that the carriage assembly can translate in relation to the first mounting surface between a stowed position and a deployed position. The carriage assembly also includes a second portion fixed to the first portion and configured to engage and retain a first portion of the elongated object.

The system further includes a forward support assembly configured to engage and retain a second portion of the elongated object. The forward support assembly is mounted on the second portion of the carriage assembly and is movable linearly in relation to the second portion of the carriage assembly between a forward position and a rearward position. The base assembly is configured to rotate the carriage assembly in the relation to the mounting surface between a substantially horizontal orientation and a tilted orientation.

In another aspect of the disclosed technology, the forward support assembly includes a shelf engageable with the second portion of the carriage assembly so that the shelf is movable linearly in relation to the second portion of the carriage assembly. The forward support assembly also includes a first end cap mounted on the shelf and configured to receive and restrain the second portion of the elongated object.

In another aspect of the disclosed technology, the first end cap is configured to receive and restrain the second portion of the elongated object while the carriage assembly moves between the stowed and deployed positions and the carriage assembly is in the substantially horizontal orientation.

In another aspect of the disclosed technology, the first end cap is configured to receive and restrain the second portion of the elongated object while the forward support assembly moves between the forward and rearward positions and the carriage assembly is in the deployed position and the tilted orientation.

In another aspect of the disclosed technology, the second portion of the carriage assembly includes an upper shelf, the upper shelf having a major portion and a lip that extends from the major portion. The shelf of the forward support assembly includes a major portion and a lip that extends from the major portion of the shelf of the forward support. The lip of the upper shelf is engageable with the lip of the shelf of the forward support assembly to guide the forward support assembly between the forward and rearward positions of the forward support assembly.

In another aspect of the disclosed technology, the carriage assembly further includes a second end cap mounted on the upper shelf and configured to receive and restrain the first portion of the elongated object while the carriage assembly moves between the stowed and deployed positions.

In another aspect of the disclosed technology, the carriage assembly and the forward support assembly are configured to position the second end cap higher than the first end cap when the carriage assembly is in the deployed position and the tilted orientation and the forward support assembly is in the forward position.

In another aspect of the disclosed technology, the carriage assembly and the forward support assembly are configured so that the second end cap lowers as the forward support assembly moves from the forward to the rearward position while the carriage assembly is in the deployed position and the tilted orientation.

In another aspect of the disclosed technology, the first portion of the carriage assembly includes a lower shelf, the lower shelf having a major portion and a lip that extends from the major portion. The base assembly includes a guide engageable with the lip of the lower shelf to guide the carriage assembly between the stowed and deployed positions of the carriage assembly.

In another aspect of the disclosed technology, the second portion of the carriage assembly is configured to engage and retain a first end of the elongated object, and the forward support assembly is configured to engage and retain a second end of the elongated object.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

The inventive concepts are described with reference to the attached figures, wherein like reference numerals represent like parts and assemblies throughout the several views. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

FIG. 1 is a side view of a gantry system installed on a fire engine and showing a carriage assembly of the gantry system in a deployed position and in a tilted orientation, with two hard sleeves stowed on the gantry system;

FIG. 2 is a side view of the gantry system and fire engine shown in FIG. 1, depicting the carriage assembly in a stowed position and in a horizontal orientation;

FIG. 3 is a side view of the gantry system and the fire engine shown in FIGS. 1 and 2, depicting the carriage assembly in the stowed position and in the horizontal orientation;

FIG. 4 is a top-rear perspective side view of the gantry system and the fire engine shown in FIGS. 1-3, depicting the carriage assembly in the deployed position and in the tilted orientation;

FIG. 5 is a perspective view of a tray assembly of the gantry system shown in FIGS. 1-4;

FIGS. 6-8 are magnified views of various components of the tray assembly shown in FIG. 5;

FIG. 9 is a top-rear perspective side view of the gantry system and the fire engine shown in FIGS. 1-8, depicting the tray assembly and the carriage assembly separated from a base assembly of the gantry system for clarity of illustration, and depicting a receiving member of the base in a level orientation;

FIG. 10 is a magnified view of the base assembly and portions of the tray assembly and the carriage assembly as depicted in in FIG. 9;

FIG. 11 is a top-front perspective view of the base assembly shown in FIGS. 9 and 10, depicting the receiving member of the base assembly in a tilted orientation;

FIGS. 12 and 13 are respective top and side views of the gantry system and the fire engine shown in FIGS. 1-11 without the tray assembly and the carriage assembly, for clarity of illustration;

FIGS. 14 and 15 are magnified side and rear views, respectively, of the gantry system shown in FIGS. 1-13, depicting the carriage assembly in the stowed position and in the horizontal orientation;

FIG. 16 is a top-rear perspective view of a shelf guide of the gantry system shown in FIGS. 1-15;

FIG. 17 is a rear view of an anti-torque and stop bracket of the gantry system shown in FIGS. 1-16;

FIG. 18 is a magnified side view of a forward-most portion of the gantry system shown in FIGS. 1-17;

FIG. 19 is a top-rear perspective side view of the gantry system and the fire engine shown in FIGS. 1-18, depicting the carriage assembly in the deployed position and in the tilted orientation, and depicting a pull handle rail of a pull handle assembly of the gantry system in a stowed position;

FIG. 20 is a magnified view of a portion of the pull handle rail shown in FIG. 19;

FIG. 21 is a magnified view of rearward portions of the tray and carriage assemblies of the gantry system shown in FIGS. 1-20;

FIG. 22 is a magnified view of portions of the pull handle assembly and the carriage assembly of the gantry system shown in FIGS. 1-21;

FIG. 23 is a magnified view of a portion of the pull handle assembly shown in FIGS. 19-22, with a channel stiffener of the pull handle assembly removed for clarity of illustration;

FIG. 24 is an exploded view of the pull handle assembly shown in FIGS. 19-23;

FIG. 25 is a magnified view of a portion of the pull handle assembly as depicted in FIG. 24;

FIG. 26 is an exploded view of the carriage assembly of the gantry system shown in FIGS. 1-25;

FIGS. 27-30 are top-rear perspective, top, rear, and side views, respectively, of an alternative embodiment of the gantry system shown in FIGS. 1-26;

FIG. 31 is a side view of another alternative embodiment of the gantry system shown in FIGS. 1-26, installed on a fire engine with an extension ladder stowed on the gantry system, showing a carriage assembly of the gantry system in a stowed position and in a level orientation, and showing a forward support assembly of the gantry system in a forward position;

FIG. 32 is a side view of the gantry system and fire engine shown in FIG. 31, showing the carriage assembly in a deployed position and the level orientation, and showing the forward support assembly in the forward position;

FIG. 33 is a side view of the gantry system and fire engine shown in FIGS. 31 and 32, showing the carriage assembly in the deployed position and in a tilted orientation, and showing the forward support assembly in the forward position,

FIG. 34 is a side view of the gantry system and fire engine shown in FIGS. 31-33, showing the carriage assembly in the deployed position and tilted orientation, and showing the forward support assembly in a rearward position;

FIG. 35 is a top-perspective view of the gantry system and fire engine shown in FIGS. 31-34, showing the carriage assembly in the stowed position and in the level orientation, and showing the forward support assembly in the forward position;

FIG. 36 is a magnified view of the area designated “XXXVI” in FIG. 34;

FIG. 37 is a magnified view of the area designated “XXXVII” in FIG. 34;

FIG. 38 is a magnified view of the area designated “XXXVIII” in FIG. 31;

FIG. 39 is a cross-sectional view taken through the line XXXIX-XXXIX of FIG. 31; and

FIG. 40 is a cross-sectional view taken through the line XXXX-XXXX of FIG. 31.

### DETAILED DESCRIPTION

The inventive concepts are described with reference to the attached figures, wherein like reference numerals represent like parts and assemblies throughout the several views. The figures are not drawn to scale and are provided merely to illustrate the instant inventive concepts. The figures do not limit the scope of the present disclosure or the appended claims. Several aspects of the inventive concepts are described below with reference to example applications for illustration. It should be understood that numerous specific details, relationships, and methods are set forth to provide a full understanding of the inventive concepts. One having ordinary skill in the relevant art, however, will readily recognize that the inventive concepts can be practiced without one or more of the specific details or with other methods. In other instances, well-known structures or operation are not shown in detail to avoid obscuring the inventive concepts.

The figures depict a gantry system 10. The system 10 can be used to stow and quickly retrieve two tubular members in the form of hard suction hoses, or hard sleeves 11 used in firefighting operations. The system 10 can be used to stow and retrieve other types of rigid or semi-rigid tubular members in other applications of the system 10.

The system 10 is configured for use on an emergency vehicle, such as a fire engine 300. The system 10 can be used on other types of vehicles. The system 10 also can be used in non-vehicular applications. For example, the system 10 can be used to store and retrieve the hard sleeves 11 or other types of equipment from an elevated location in a firehouse, warehouse, or other structure.

The “forward” and “rearward” directions, as referred to herein in relation to the system 10, correspond to the respective forward and rearward directions of the fire engine 300.

The system 10 includes a base assembly 12, a carriage assembly 14, a double-tray hose assembly 18 mounted on the carriage assembly 14, and a pull handle assembly 19. The tray assembly 18 is configured to hold the two hard sleeves 11 in a vertical stack. Each hard sleeve 11 can have a length of, for example, about ten feet. More than two hard sleeves 11, of shorter length than ten feet, can be stowed on the tray assembly 18. For example, two hard sleeves 11 of five-foot length can be stowed on the upper level of the tray assembly 18, and two hard sleeves 11 of five-foot length similarly can be stowed on the lower level of the tray assembly 18.

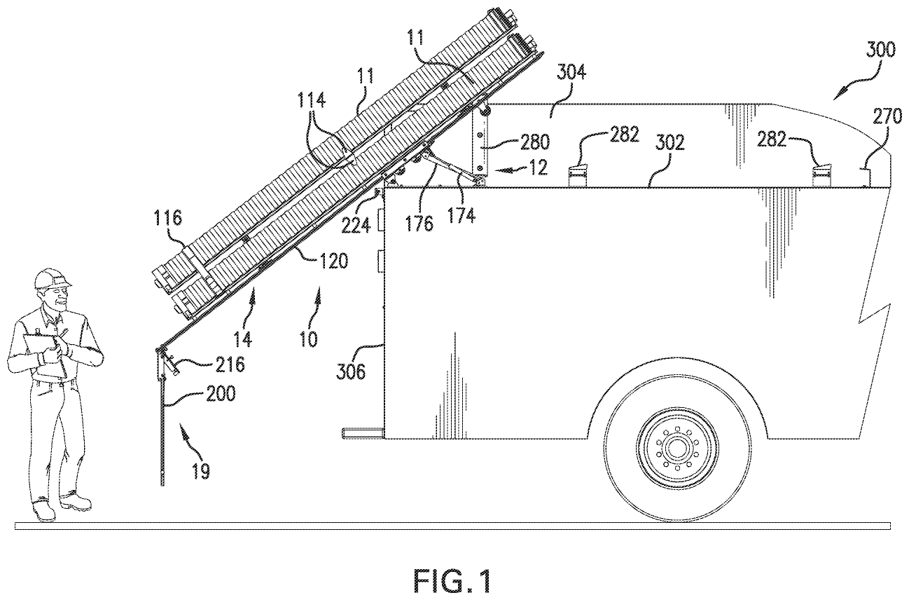

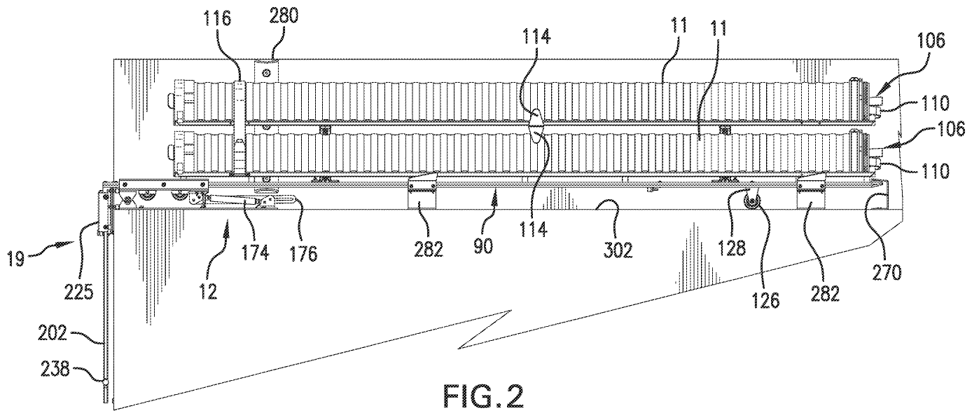

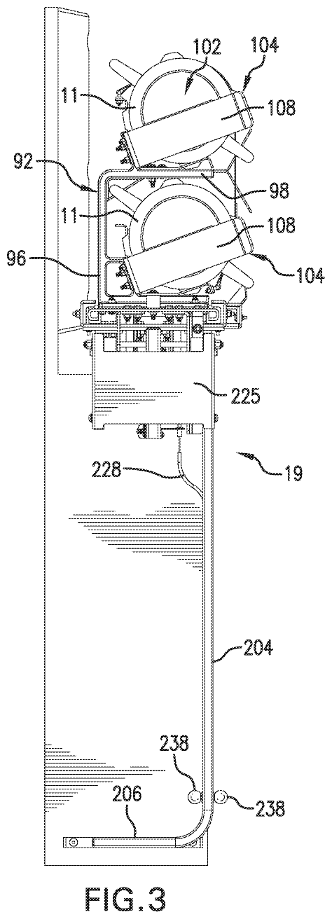

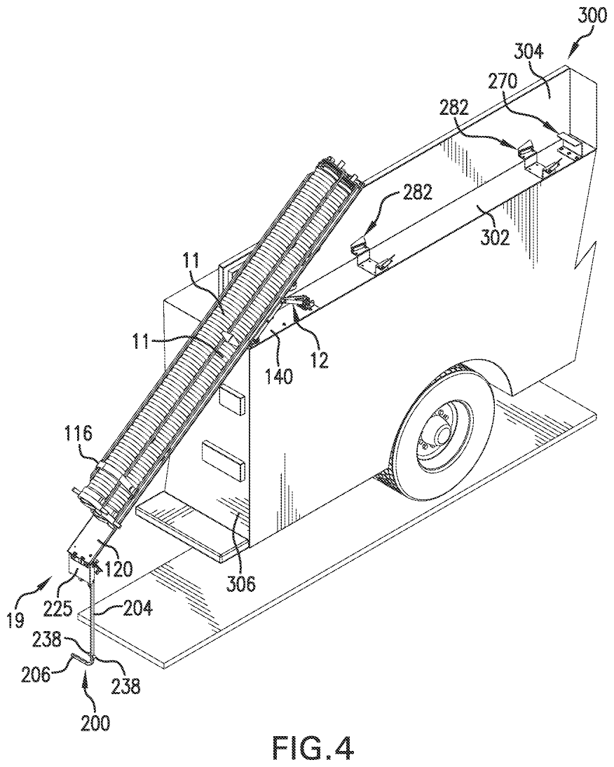

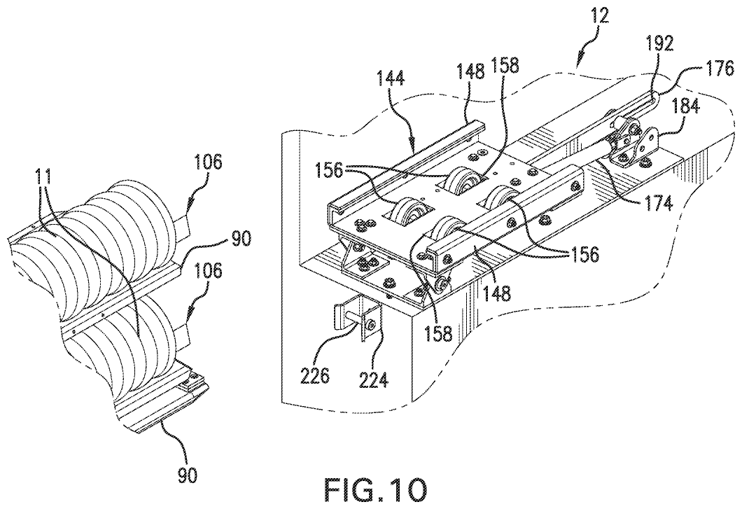

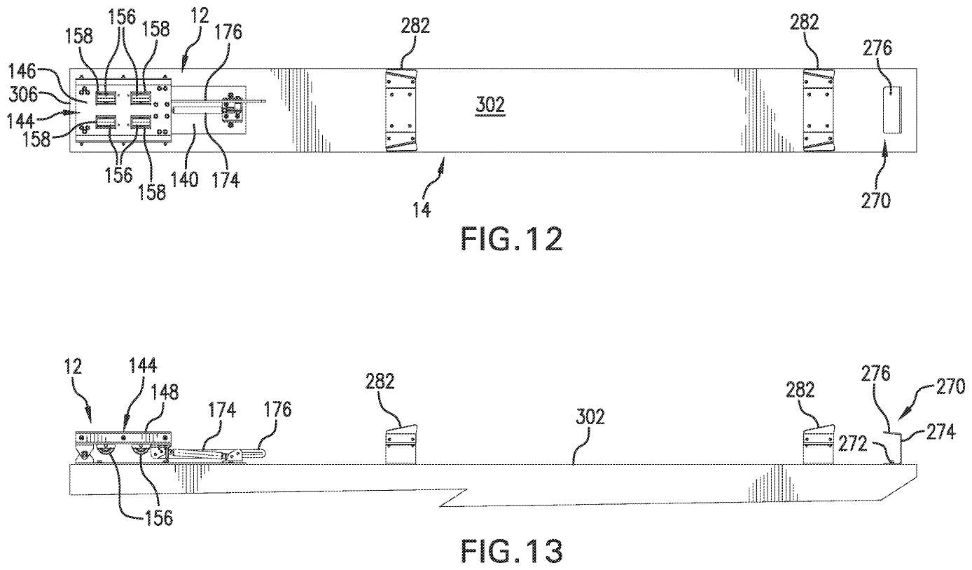

The tray assembly 18 is mounted on the carriage assembly 14. The base assembly 12 can be mounted, for example, on an elevated, horizontally-oriented, upward-facing shelf or surface 302 of the fire engine 300. The carriage assembly 14 is mounted on the base assembly 12. The carriage assembly 14 (with the tray assembly 18 mounted thereon) is configured to move linearly in relation to the base assembly 12 (and the mounting surface 302) between a stowed position shown in FIGS. 2 and 3, and deployed position shown in FIGS. 1 and 4. In addition, the carriage assembly 14 is configured to rotate between a horizontal or level orientation at which the carriage assembly 14 can be moved between its stowed and deployed positions; and a tilted orientation at which the hard sleeves 11 can be accessed and removed from the tray assembly 18 by a firefighter or other user on the ground, without the need for ladders, steps, or other provisions to elevate the user above the ground. The carriage assembly 14 is shown in its horizontal orientation in FIGS. 2, 3, and 9-14. The carriage assembly 14 is shown in its tilted orientation in FIGS. 1, 4, and 11.

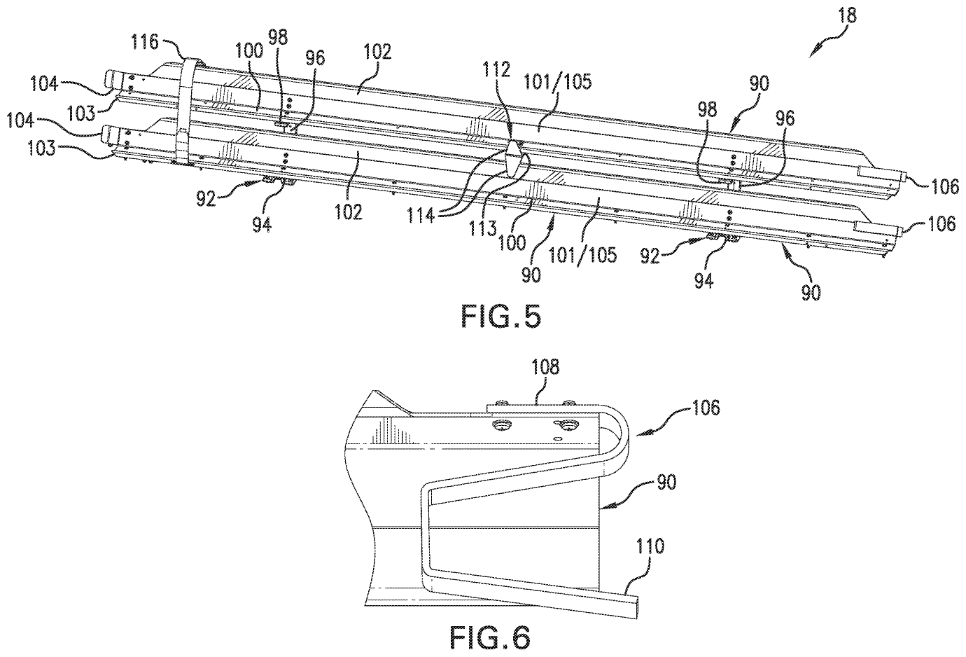

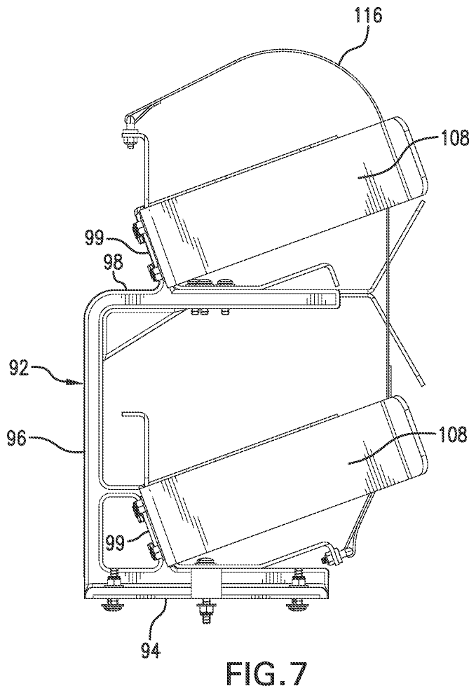

Referring to FIGS. 5-8, the tray assembly 18 includes two trays 90, and two tray brackets 92. Each tray bracket 92 is substantially C-shaped, and includes a lower leg 94; a center portion 96 that adjoins the lower leg 94 and is substantially perpendicular to the lower leg 94, and an upper leg 98 that adjoins the center portion 96 and is substantially perpendicular to the center portion 96. Each tray bracket 92 also includes two flanges 99 that adjoin and extend upward at an angle from the respective lower leg 94 and upper leg 98. The lower leg 94 of the bracket 92 is mounted on a shelf 120 of the carriage assembly 14 using fasteners or other suitable means, so that the tray assembly 18 moves with the carriage assembly 14.

Each tray 90 includes a lower portion 100, an intermediate portion 101 that adjoins the lower portion 100, and a side portion 102 that adjoins the intermediate portion 101. The lower portion 100 has a substantially horizontal orientation when the carriage assembly 14 is in its level orientation. The side portion 102 has a substantially vertical orientation when the carriage assembly 14 is in its level orientation. The intermediate portion 101 has an angled orientation that approximately matches the angled orientation of the flanges 99 of the tray brackets 92.

The lower portion 100 of the lower tray 90 rests on the lower legs 94 of the respective tray brackets 92. The intermediate portion 101 of the lower tray 90 rests on the flanges 99 that extend from the lower legs 94 of the respective tray brackets 92. The lower tray 90 is connected to the lower legs 94, and to the flanges 99 that extend from the lower legs 94, by fasteners that extend through the lower portion 100 and the intermediate portion 101 of the upper tray 90, or by other suitable means.

Similarly, the lower portion 100 of the upper tray 90 rests on the upper legs 98 of the respective tray brackets 92. The intermediate portion 101 of the upper tray 90 rests on the flanges 99 that extend from the upper legs 98 of the respective tray brackets 92. The upper tray 90 is connected to the upper legs 98, and to the flanges 99 that extend from the upper legs 98, by fasteners that extend through the lower portion 100 and the intermediate portion 101 of the upper tray 90, or by other suitable means.

The hard sleeves 11 rest on the lower portion 100 and the intermediate portions 101 of the respective upper and lower trays 90 when the hard sleeves 11 are stowed on the trays 90. Each tray 90 also includes a lip 103, visible in FIG. 5, that adjoins the lower portion 100. The lip 103, the intermediate portion 101, and the side portion 102 help to restrain the hard sleeve 11 from lateral movement in relation to the tray 90. A low-friction coating or tape 105, or other provisions can be disposed on the intermediate portions 101 of the trays 90 to reduce friction between the hard sleeves 11 and the trays 90, thereby making it easier for the user to load and retrieve the hard sleeves 11 onto and from the trays 90. The tape 105 can be formed, for example, from HDPE.

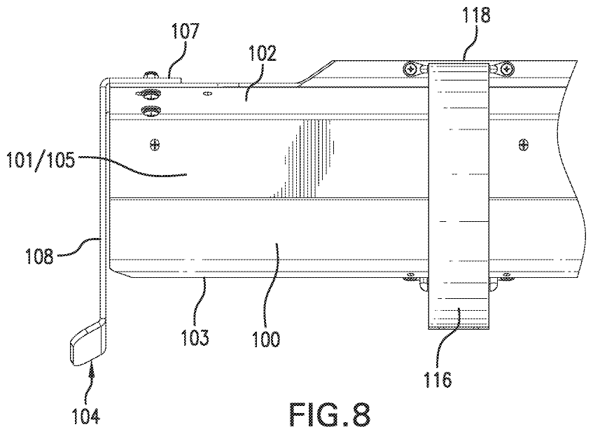

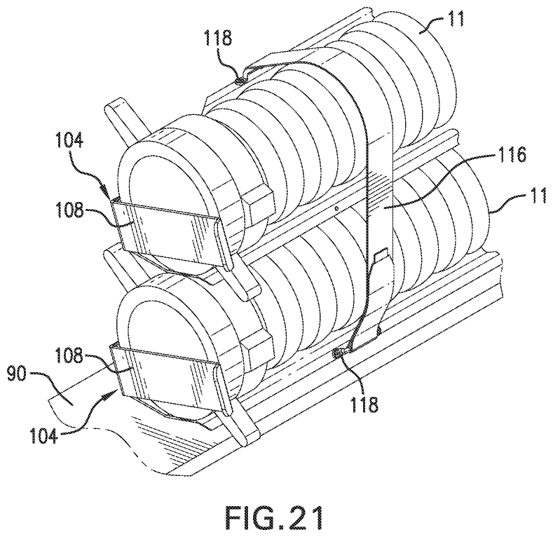

Referring to FIGS. 5, 7, 8, 14, 15, and 21, the tray assembly 18 also includes two stops 104. The stops 104 are substantially L-shaped. Each stop 104 has a first leg 107, visible in FIG. 8, and a second leg 108 that adjoins that first leg 107 and is substantially perpendicular to the first leg 107. The first leg 107 of each stop 104 is connected to the intermediate portion 101 of a respective one of the trays 90, at the rearward end of the tray 90, using a suitable means such as fasteners. The stops 102 restrain the hard sleeves 11 from rearward movement in relation to the trays 90.

Referring to FIGS. 5, 6, and 18, the tray assembly 18 also includes two hose catches 106. Each hose catch 106 has a substantially straight first portion 108, and a substantially U-shaped second portion 110 that adjoins the first portion 108. The first portion 108 is connected to the intermediate portion 101 of a respective one of the trays 90, at the forward end of the tray 90, using a suitable means such as fasteners. The second portions 110 become disposed within the respective hard sleeves 11 when the hard sleeves 11 are positioned on the trays 90, so that the hose catches 106 restrain the hard sleeves 11 from movement in relation to the trays 90.

The tray assembly 18 also includes an anti-roll bracket 112, shown in FIG. 5. The anti-roll bracket 112 is connected to the lower portion 100 of the upper tray 90, by a suitable means such as fasteners. The anti-roll bracket 112 has a first member 113 that extends from the lower portion 100 of the upper tray 90, and between the upper and lower hard sleeves 11. The anti-roll bracket 112 also includes two lips 114 that adjoin an end of the first member 113. One of lips 114 extends upwardly and the other lip 114 extends downwardly, so that lips 114 restrain the hard sleeves 11 from lateral movement away from their respective trays 90.

Referring to FIGS. 5 and 8, the tray assembly 18 also includes a strap 116 configured to restrain the hard sleeves 11 from upward and lateral movement. The strap 116 can be threaded through, and looped around two footman loops 118 (or other suitable anchoring points) mounted respectively on the lower portion 100 of the lower tray 90, and the side portion 102 of the upper tray 90. After the strap 116 has been looped around the footman loops 118, the strap 116 can be pulled so as to tighten the strap 116 against the hard sleeves 11, and the second end of the strap 116 can be secured to an adjacent portion of the strap 116 using hook and loop fasteners or other suitable means, so that the strap 116 restrains the hard sleeves 11 as noted above.

In the exemplary application illustrated herein, the system 10 is mounted adjacent to a rear vertical wall or shelf 304 of the fire engine 300. The system 10 can be configured in a left or right-handed configuration to facilitate installation of the system adjacent the rear vertical shelf on either side of the fire engine 300. In particular, the left or right-handed configuration of the system 10 can be reversed to accommodate mounting on either side of the fire engine 300 by swapping the respective positions of the stop 104 and the hose catch 106 on each of the trays 90.

In alternative embodiments, the tray assembly 18 can include more than two trays 90. For example, in some embodiments, the tray assembly 18 can include three of the trays 90 arranged in a vertical stack.

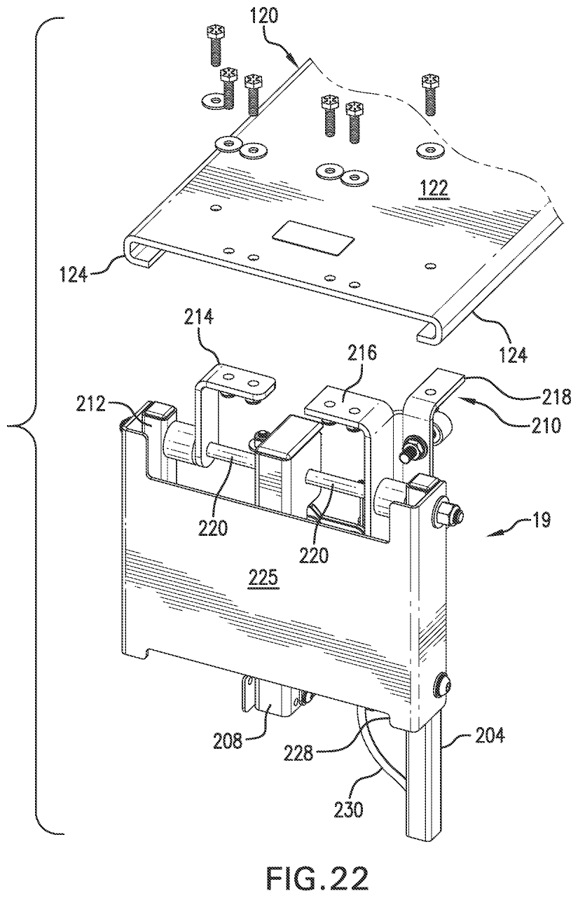

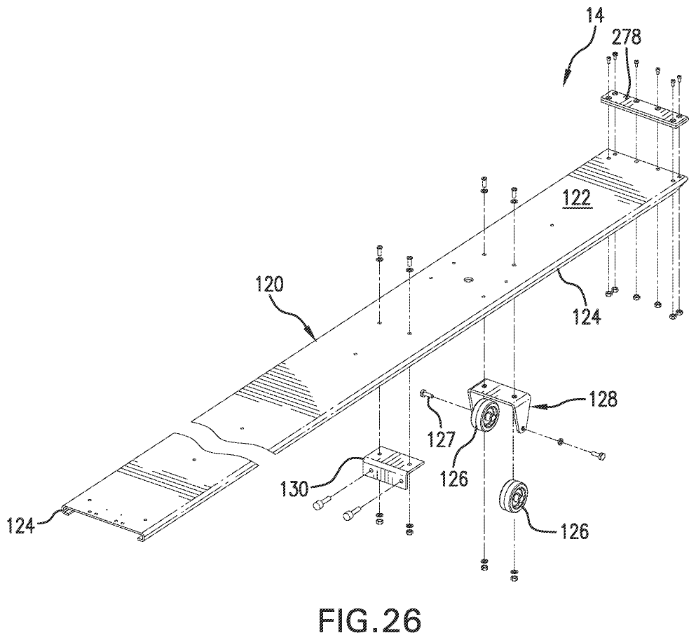

The tray 120 of the carriage assembly 14 includes a substantially planar central portion 122, and two C-shaped lips 124 that adjoin, and extend downward from respective sides of the central portion 122 as can be seen in FIGS. 22 and 26. The tray assembly 18 is mounted on the central portion 122, and thus translates linearly and angularly with the main rail assembly 14.

The carriage assembly 14 also includes two wheels 126 and a wheel bracket 128, visible in FIGS. 2 and 26. The wheel bracket 128 is mounted on an underside of the central portion 122 of the tray 120 using fasteners or other suitable means. The wheels 126 are mounted on the wheel bracket 128 by fasteners 127 that facilitate rotation of the wheels 126 in relation to the wheel bracket 128. The wheels 126 partially support the weight of the carriage assembly 14 (and the tray assembly 18 mounted thereon), and roll along the mounting surface 302 of the fire engine 300 as the carriage assembly 14 moves between its stowed and deployed positions.

The carriage assembly 14 also includes an L-shaped shelf stop 130, shown in FIG. 26. The shelf stop 130 is mounted on an underside of the central portion 122 of the shelf 120 using a suitable means such as fasteners, and is configured to contact a receiving member 144 of the base assembly 12 when the carriage assembly 14 reaches its deployed (rearward-most) position. The resulting interference between the receiving member 144 and the shelf stop 130 prevents further rearward movement of the carriage assembly 14.

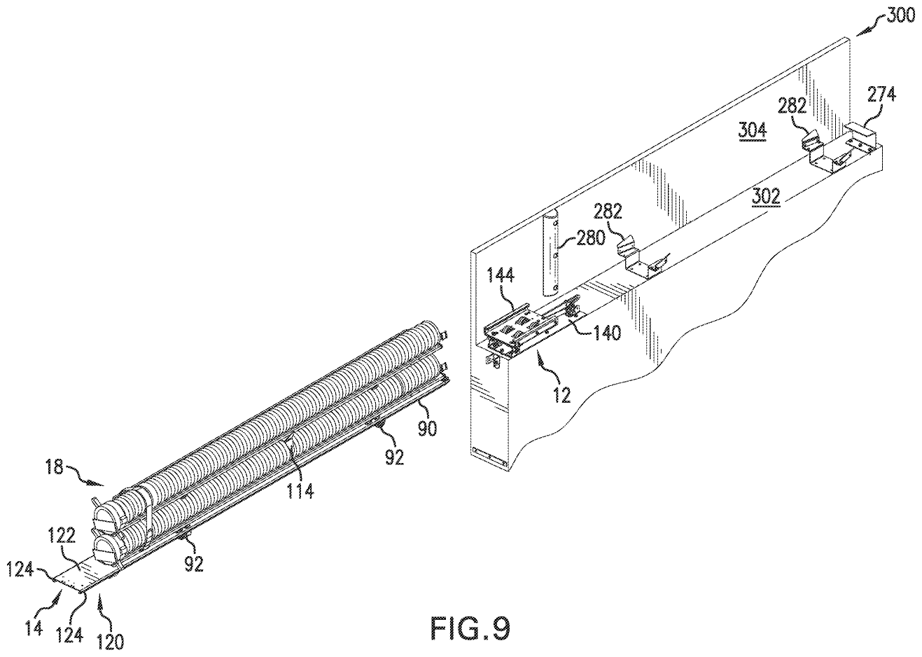

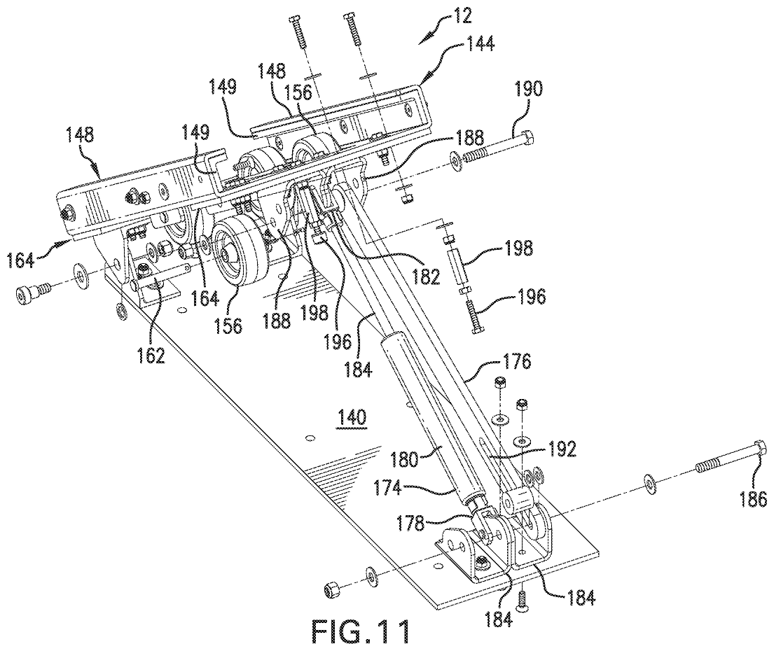

Referring to FIGS. 9-15, the base assembly 12 includes a base plate 140, and the receiving member 144. The base plate 140 is configured to be mounted on the mounting surface 302 of the fire engine 300, using fasteners or other suitable means. The receiving member 144 includes a substantially flat central portion 146, and two L-shaped guide portions 148 that adjoin, and extend upward from the central portion 146 as can be seen in FIG. 11. Two L-shaped plastic wear sleeves 149 are connected to the guide portions 148, so that the wear sleeves 149 line the inwardly and downwardly facing surfaces of the guide portions 148. Each sleeve 149 and the adjacent surface of the central portion 146 form a respective channel 150. The channel 150 receives a respective lip 124 of the shelf 120 of the carriage assembly 14. The sleeve 149 guides the corresponding lip 124 as the lip 124 moves through the channel 150 during movement of the carriage assembly 14 between its stowed and deployed positions

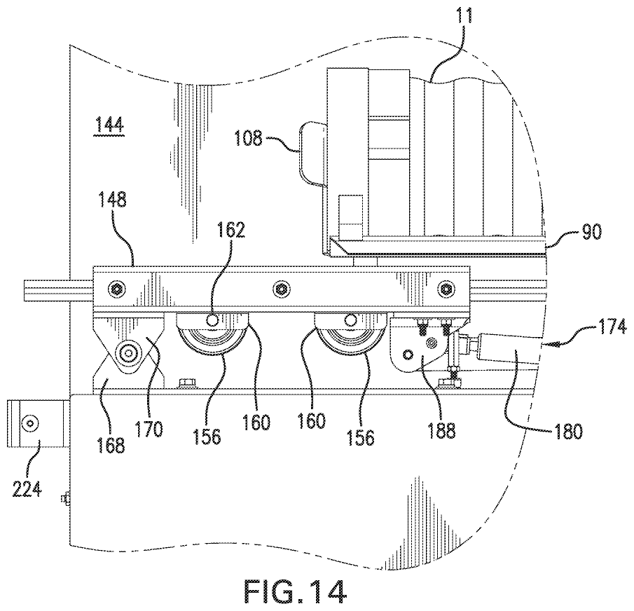

The base assembly 12 also includes four wheels 156. The wheels 156 are disposed in respective openings 158 formed in the central portion 146 of the receiving member 144. Each wheel 156 is coupled to the central portion 146 by a respective pair of brackets 160 located on the underside of the central portion 146, and a respective pin 162 as shown in FIG. 14. The pin 162 extends through the wheel 156 and the brackets 160, and is coupled to the brackets 160 using a cotter pin or other suitable means, so that the wheel 156 is secured to, and can rotate in relation to the brackets 160 and the receiving member 144. The wheels 156 contact the underside of the central portion 122 of the shelf 120 of the carriage assembly 14, and thus support the carriage assembly 14 while allowing the carriage assembly 14 to move in relation to the receiving member 144 as the carriage assembly 14 moves between its stowed and deployed positions.

The brackets 160 can be formed, for example, by cutting though the sheet of material from which the receiving member 144 is formed, with the cuts matching the shape of the brackets 160; and then bending, punching, or otherwise urging the material adjacent the cuts downward to form the brackets 160.

Referring to FIG. 11, the base assembly 12 also includes two stiffener plates 164. The stiffener plates 164 are mounted on the underside of the central portion 146 of the receiving member 144, proximate the respective forward and rearward ends of the receiving member 144.

The receiving member 144 is coupled to the base plate 140 by way of two brackets 168 mounted on the base plate 140, proximate a rearward end thereof; two brackets 170 mounted on the rearward stiffener plate 164; and a two fasteners 172. Each fastener 172 extends through a corresponding bracket 168 and a corresponding bracket 170, and facilitates rotation of the backet 170 and the attached receiving member 144 in relation to the bracket 168, the base plate 140, and the mounting surface 302 of the fire engine 300, so that the carriage assembly 14, with the tray assembly 18 attached thereto, can rotate between its level and tilted orientations.

The base assembly 12 also includes a damper 174, and a stop 176. The damper 174 is configured to dampen the rotational movement of the receiving member 144. The stop 176 is configured to restrain the extent to which the receiving member 144 can rotate when rotating toward its tilted orientation.

The damper 174 includes a first mounting bracket 178 connected to the outer cylinder 180 of the damper 174; and a second mounting bracket 182 connected to the rod 184 of the damper 174. The damper 174 is coupled to the base plate 140 by way of two brackets 184 mounted on the base plate 140, and a fastener 186 that extends through the brackets 184 and the first mounting bracket 178 of the damper 174, so that the damper 174 can rotate in relation to the brackets 184 and the base plate 140. The damper 174 is coupled to the receiving member 144 by way of two brackets 188 mounted on the receiving member 144, and a fastener 190 that extends through the brackets 188 and the second mounting bracket 182 of the damper 174, so that the damper 174 can rotate in relation to the brackets 188 and the receiving member 144.

The stop 176 is coupled to the base plate 140 by way of one of the brackets 184, and the fastener 186, which extends through a slot 192 formed in the stop 176, proximate a first end of the stop 176, so that the stop 176 can rotate in relation to the brackets 184 and the base plate 140. The stop 176 is coupled to the receiving member 144 by way of one of the brackets 188, and the fastener 190, which extends through a hole formed in the stop 176, proximate a second end of the stop 176, so that the stop 176 can rotate in relation to the brackets 188 and the receiving member 144.

Rotation of the receiving member 144 from its level orientation to its tilted orientation causes the rod 184 of the damper 174 to be drawn out of the cylinder 180 due to the movement of the receiving member 144 and the attached brackets 188 away from the base plate 140 and the attached brackets 184. The movement of the rod 184 in turn causes the piston and fluid (not shown) within the cylinder 180 to exert a force on the receiving member 144 by way of the brackets 188 and the fastener 190. This force resists the rotation of the receiving member 144, and is proportional to the angular velocity of the receiving member 144. Similarly, rotation of the receiving member 144 from its tilted orientation to its level orientation causes the rod 184 to retract into the cylinder 180, which in turn causes the damper 174 to generate a force that resists the rotation of the receiving member 144 toward its level orientation, with the magnitude of the resistance being proportional to the angular velocity of the receiving member 144. The damper 174 can be a type of damper other than a piston damper in alternative embodiments.

Under normal operating conditions, the damper 174 also acts as a stop that limits the range of rotation of the receiving member 144 between its level and tilted orientations. The stop 176 is configured to limit the rotation of the receiving member 144 in the event the damper 174 fails to act as a rotational stop due to, for example, breakage or other malfunction of the damper 174. In particular, rotation of the receiving member 144 from its level orientation to its tilted orientation results in relative movement between the slot 192 in the stop 176, and the pin 186 disposed within the slot 176. This movement causes the pin 186 to be drawn (relative to the slot 192) from the rearward end to the forward end of the slot 192 as the receiving member 144 and the attached brackets 188 rotate away from the base plate 140 and the attached brackets 184. Continued rotation of the receiving member 144 toward its tilted orientation eventually causes the pin 186 to reach the forward end of the slot 192 at about the point the receiving member 144 reaches its tilted orientation. In the event the damper 174 fails to limit further rotational movement of the receiving member 144, interference between the pin 186 and the adjacent surface of the stop 176 will prevent further rotation of the receiving member 144.

Similarly, rotation of the receiving member 144 from its tilted orientation to its level orientation causes the pin 186 to be drawn (relative to the slot 192) from the forward end to the rearward end of the slot 192. Continued rotation of the receiving member 144 toward its level orientation eventually causes the pin 186 to reach the rearward end of the slot 192 at about the point the receiving member 144 reaches its level orientation, with the resulting interference between the pin 186 and the adjacent surface of the stop 176 preventing further rotation of the receiving member 144 if the damper 174 fails to stop such movement.

In the exemplary application depicted in the figures, the system 10 is located adjacent to a vertical wall or shelf 304 of the fire engine 300. The base assembly 12 and the carriage assembly 14 can be configured so that the rearward ends of the hard sleeves 11 are located forward of the rearward end of the vertical shelf 304 when the carriage assembly 14 is in its stowed position, i.e., the rearward end of the main rail 120 is located forward of the rearward end of the base assembly 12 when the carriage assembly 14 is in its stowed position. This feature can help ensure that the hard sleeves 11 do not cover or otherwise interfere with the viewing of an emergency beacon (not shown) that may be mounted at or proximate the rearward end of the vertical shelf 304.

Referring to FIG. 11, the base assembly 12 further includes two jack bolts that facilitate leveling of the receiving member 144, so that the lips 124 of the shelf 120 can move smoothly through the respective channels 150 in the receiving member 144. The bolts 196 engage respective coupling nuts fastened to the underside of the central portion 146. The bolts 196 extend downward from their respective coupling nuts 198, so that the heads of the bolts contact the base plate 140. The position of each bolt 196 within its respective coupling nut 198 can be adjusted to vary the extent to which the bolt 196 extends downward from the coupling nut 198 (and the attached receiving member 144), which in turn can vary the orientation of the receiving member 144.

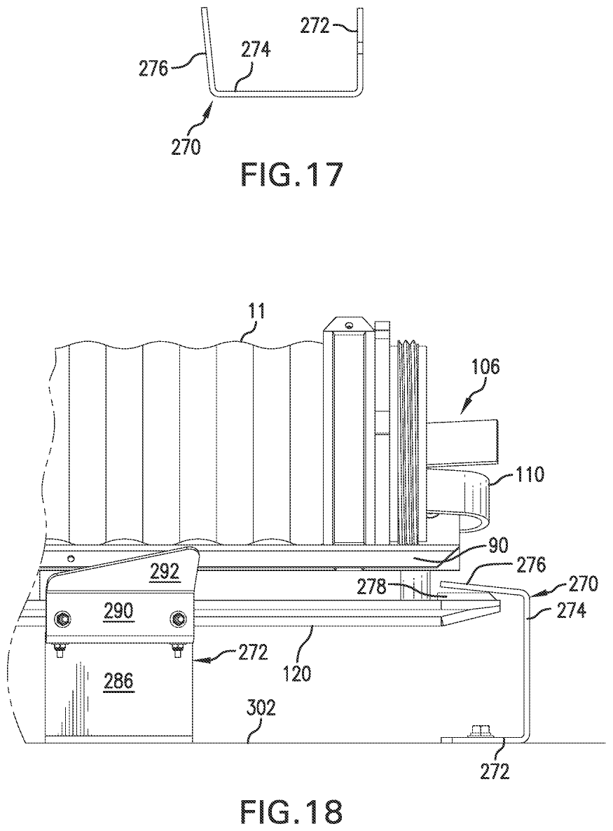

Referring to FIGS. 17 and 18, the system 10 also includes an anti-torque and stop bracket 270. The bracket 240 is mounted on the mounting surface 302 of the fire engine 300, and is positioned so as to engage the forward end of the shelf 120 of the carriage assembly 14 when the carriage assembly 14 is in its stowed (forward-most) position. The bracket 270 is substantially C-shaped, and includes a first portion 272, and a second portion 274 that adjoins the first portion 272 and is substantially perpendicular to the first portion 272. The bracket 270 further includes a third portion 276 that adjoins the second portion 274, is substantially perpendicular to the second portion 274, and is substantially parallel to the first portion 272. The first portion 272 is connected to the mounting surface 302 by fasteners or other suitable means.

The leading edge of the shelf 120 of the carriage assembly 14 contacts the second portion 274 of the bracket 270 as the carriage assembly 14 reaches its stowed position. The resulting interference between the shelf 120 and the second portion 274 prevents further movement of the carriage assembly 14 in the forward direction.

A wear strip 278 is connected to the upwardly-facing surface of the shelf 120, proximate the forward end of shelf 120, as shown in FIG. 18. The bracket 270 is configured so that the underside of the third portion 276 of the bracket 270 contacts the wear strip 278 as the carriage assembly 14 reaches its stowed position. The resulting interference between the wear strip 278 and the underside of the third portion 276, in conjunction with the contact between the leading edge of the shelf 120 and the second portion 274 of the bracket 270, discourages lateral movement of the forward end of the shelf 120 when the carriage assembly 14 is in its stowed position.

The system 10 further includes a bumper 280, visible in FIGS. 2 and 9. The bumper 280 is mounted on the vertical shelf 304 of the fire engine 300. The bumper 280 is positioned at a front-to-back location approximately coincident with the forward end of the base assembly 12. The bumper 280 is configured to contact the shelf 120 of the carriage assembly 14 when the shelf 120 is displaced laterally. Such lateral displacement can occur, for example, when the user exerts a lateral, or transverse force on the pull handle assembly 19 while the carriage assembly 14 is in its deployed and tilted orientation, which in turn can cause the carriage assembly 14 and the attached tray assembly 18 to rotate about a vertical axis passing through the base assembly 12. The bumper 280 is formed from a material that cushions the shelf 120 and the vertical shelf 304, while exerting a restraining effect on the shelf 120 that limits the above-noted lateral displacement and rotation of the carriage assembly 14. The bumper 280 is configured to extend over most, or all of the height of the vertical shelf 304. The bumper 280 can extend over substantially less than the entire height of the vertical shelf 304 in alternative embodiments.

The system 10 also includes two shelf guides 282. The shelf guides 282 are mounted on the mounting surface 302, at respective positions forward of the base assembly 12 and rearward of the anti-torque and stop bracket 270 as can be seen in FIGS. 1, 2, 4, 9, 12, and 13. The shelf guides 282 are configured to guide the carriage assembly 14 as the carriage assembly 14 moves between is stowed and deployed positions, and its level and tilted orientations.

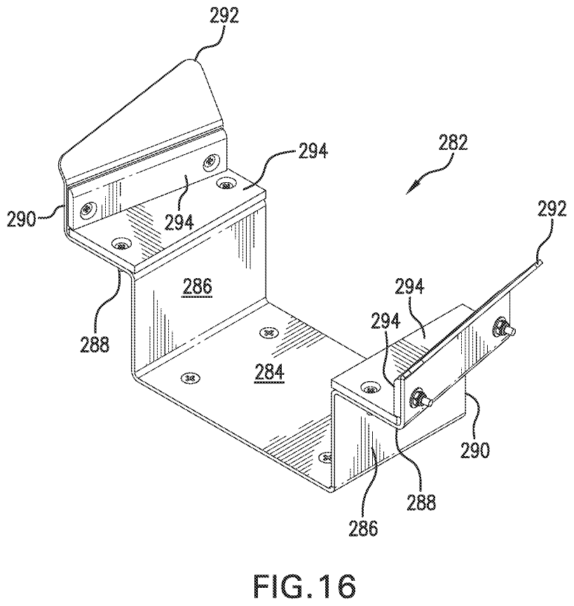

As shown in FIG. 16, each shelf guide 282 includes a bottom member 284, and two vertical members 286 that adjoin, and extend upward from the bottom member 284. The bottom member 284 is fixed to the mounting surface 302 of the fire engine 300 by fasteners or other suitable means.

The shelf guide 282 also includes two horizontal members 288 that each adjoin a respective one of the vertical members 286. Wear strips 294 are attached to the upward-facing surfaces of the horizontal members 288. The shelf guide 282 is configured so that the lips 124 of the shelf 120 rest on the wear strips 294 on the horizontal members 288 when the carriage assembly 14 is in its stowed position and its level orientation.

The shelf guide 282 further includes two vertical guides 290 that each adjoin a respective one of the horizontal members 288; and two angled guides 292 that each adjoin a respective one of the vertical guides 290. Additional wear strips 294 are attached to the inward-facing surfaces of the vertical guides 290.

The vertical guides 290 angle inwardly, i.e., toward each other, as they extend from the rearward end to the forward end of the shelf guide 282. The angled guides 292 angle outwardly, i.e., away from each other, as they extend away from their adjoining vertical guides 290. The angled orientation of the angled guides 292 can help to center the shelf 120 of the carriage assembly 14 as the main rail assembly 14 is rotated from its tilted orientation to its level orientation. The angled orientation of the vertical guides 290 can help to center the shelf 120 as the main rail assembly 14 moves from its deployed to its stowed position.

### Pull Handle Assembly

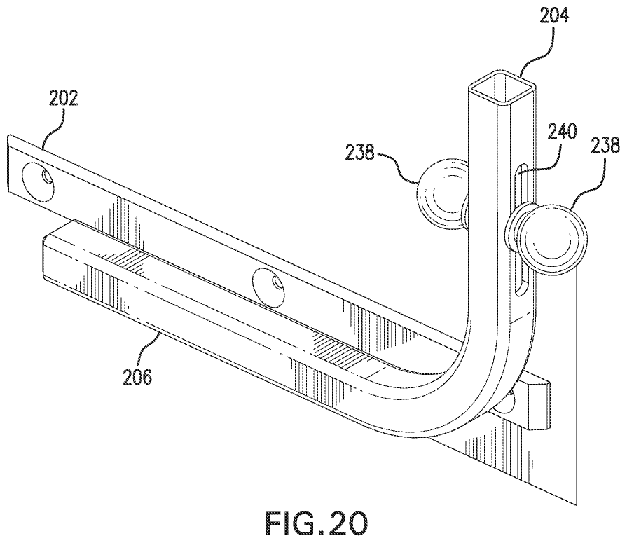

Referring to FIGS. 1-4, 19, 20, and 22-25, the pull handle assembly 19 includes a pivotable pull handle 200 the permits the user to pull the carriage assembly 14, with the attached tray assembly 18, to its deployed position while the user is standing on the ground and pulling the pull handle 200 at an orientation that is comfortable or otherwise optimal to the user. The pull handle assembly 19 also is configured to lock the carriage assembly 14 in its stowed position, to prevent inadvertent or unintended movement of the carriage assembly 14 toward its deployed position, for example, during movement of the fire engine 300.

The pull handle assembly 19 includes the pull handle 200, and a handle guard 202. The pull handle 200 has an L-shape, and includes an elongated first portion 204, and a shorter second portion 206 that adjoins the first portion 204. The handle guard 202 is mounted on a rear wall 306 of the fire engine 300, at a position adjacent the second portion 206 when the carriage assembly 14 is in its stowed position and horizontal orientation and the pull handle 200 is in a generally vertical orientation. The second portion 206 can be grasped and pulled by the user when the carriage assembly 14, with the attached tray assembly 18, is to be moved between its stowed and deployed positions and between its horizontal and tilted orientations.

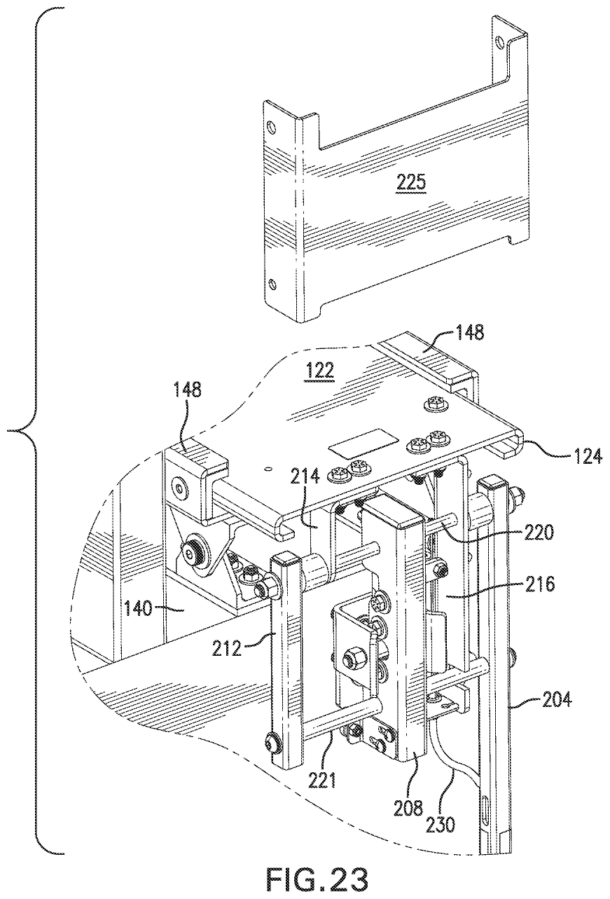

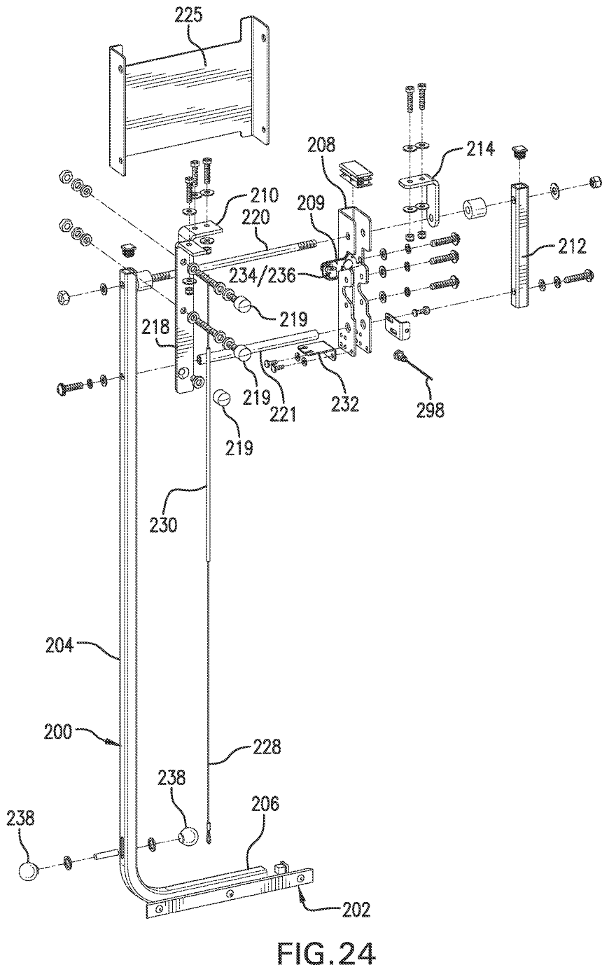

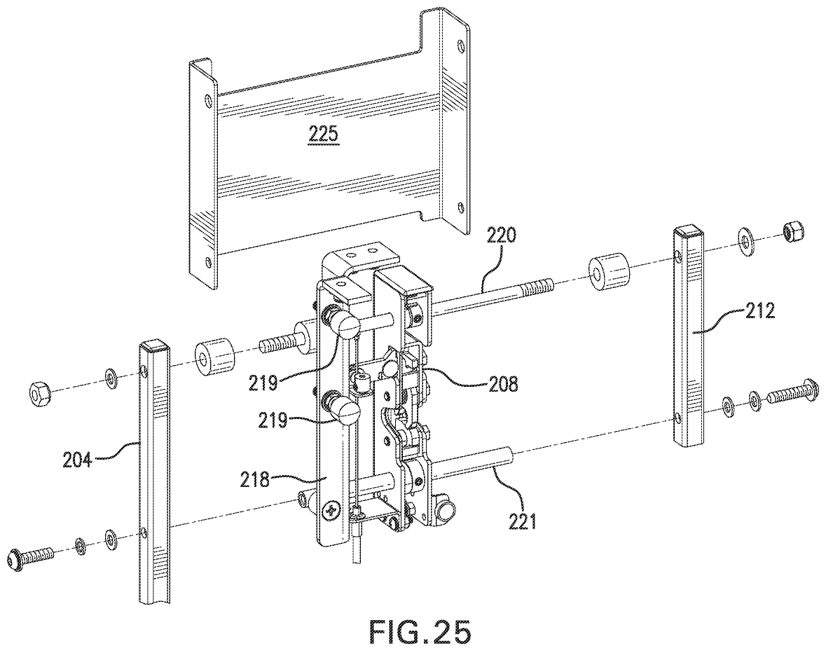

As can be seen in FIGS. 22 and 23, the pull handle assembly 19 also includes a channel bracket 208, a stop bracket 210, a pull handle rail 212, and a shelf bracket 214. The stop bracket 210 includes a first portion 216, and a second portion 218 that adjoins the first portion 216 and has an orientation that is substantially perpendicular to the orientation of the first portion 216. The second portion 218 has bumpers 219 mounted thereon to prevent direct contact between the stop bracket 210 and the rear wall 306 of the fire engine 300. The bumpers 219 are visible in FIGS. 24 and 25.

The upper ends of the shelf bracket 214 and the first and second portions 216, 218 of the stop bracket 210 are fixed to a rearward end of the shelf 120 of the carriage assembly 14 by fasteners or other suitable means.

The pull handle assembly 19 also includes a channel stiffener 225 this is disposed over the first portion 204 of the pull handle 200, the channel bracket 208, the stop bracket 210, the pull handle rail 212, and the shelf bracket 214.

Referring to FIGS. 23 and 24, the pull handle assembly 19 also includes a hinge rod 220, and a lock rod 221 that each extend through the first portion 204 of the pull handle 200, the channel bracket 208, the first portion 216 of the stop bracket 210, the pull handle rail 212, the shelf bracket 214, and the channel stiffener 225, via holes or slots formed therein. The hinge rod 220 couples the stop bracket 210 and the shelf bracket 214, which are fixed to the shelf 120 of the carriage assembly 14, to the remainder of the pull handle assembly 19, and facilitates rotation of the remainder of the pull handle assembly 19, including the pull handle 200, in relation to the carriage assembly 14.

The pull handle assembly 19 also includes a substantially U-shaped bracket 224 and a lock striker. The bracket 224 and the lock striker 226 are visible in FIGS. 1, 9, and 15. The lock striker 226 is mounted on, and spans the width of the bracket 224. The bracket 224 is mounted on the rear surface 306 of the fire engine 300, so that the bracket 224 and the lock striker 226 oppose the channel bracket 208 when the carriage assembly 14 is in its stowed position and horizontal orientation and the pull handle 200 is in a generally vertical orientation.

The pull handle assembly 19 also includes a latch 209 mounted on the channel bracket 208. The latch 209 is visible in FIG. 24. The latch 209 is configured to rotate in relation to the channel bracket 208 between a first, or locking position and a second, or release position. The pull handle assembly 19 also includes a spring configured to bias the latch 209 toward the locking position. The latch 209 is configured to securely engage the lock striker 226 when the latch 209 is in its locking position, the pull handle 200 is in a vertical orientation, and the carriage assembly 14 is in its stowed position and level orientation.

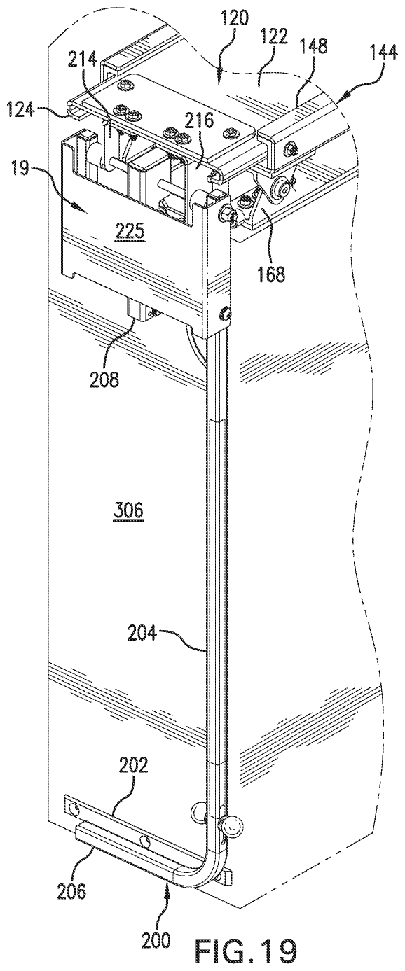

Referring to FIGS. 19, 20, and 22-24, the pull handle assembly 19 further includes a cable 228, and cable conduit 230, a cable bracket 232, a cable stop sleeve bracket 234, a cable stop sleeve 236, and a cable pull in the form of two control balls 238. The control balls 238 are connected to a lower, or first end of the cable 228. The cable 228 is routed through the interior of the first portion 204 of the pull handle 200. Slots 240 are formed near the lower end of the first portion 204 of the pull handle 200, adjacent the control balls 238, so that the lower end of the cable 228 can enter the first portion 204 and move upward and downward in relation to the first portion 204.

The cable 228 exits the first portion 204 of the pull handle 200 near the upper end of the first portion 204. Upon exiting the first portion 204, the cable 228 is routed through the cable conduit 230, which is secured to the cable bracket 232. Upon exiting the cable conduit 230, the cable 228 runs to the cable stop sleeve bracket 234, and then to the latch 209, which is secured to a second end of the cable 228.

As noted above, the latch 209 is biased in its locking position by a spring. The user can move the latch 209 from its locking position to its release position by pushing the control balls downward, to tension the cable 228 so that the cable 228 exerts a force on the latch 209 that counteracts the spring bias.

In some embodiments, the spring can be configured to assume an over-center position with respect to the rotational axis of the latch 209 when the latch 209 is in its release position, so that the latch 209 will remain in its release position until the lock striker 226 reengages the latch 209 when the pull handle 200 is returned to its vertical position while the carriage assembly is in its stowed position and its vertical orientation. In other embodiments, the spring can be configured to return the latch 209 to its locking position whenever the downward force on the control balls 238 is released.

During use, the pull handle 200 will remain secured in its stowed position until the user releases the pull handle 200 by pushing downwardly on the control balls 238 to move the latch 209 out of engagement with the lock striker 226. The user, grasping the second portion 206 of the pull handle 200, can then pull the pull handle 200 away from the rear wall 306 of the fire engine 300. The pull handle 200, along with the channel bracket 208, the pull handle rail 212, the lock rod 221, and the channel stiffener 225 rotate about the hinge rod 220, so that the pull handle 200 can assume an angular orientation that is comfortable or otherwise optimal for the user to exert a rearward force on the carriage assembly 14 to draw the carriage assembly 14, with the tray assembly 18 thereon, to its deployed position. Once the carriage assembly 14 reaches its deployed position, the user can pull the pull handle 200 downward to rotate the carriage assembly 14 to its tilted orientation at which the user can remove the hard sleeves 11 from the tray assembly 18 while standing on the ground after unfastening the strap 116.

When user wishes to stow the hard sleeves 11 after the hard sleeves 11 have been returned to and secured to their respective trays 90, the user can pull the pull handle 200 upward to rotate the carriage assembly 14 its level orientation. The user then can push the pull handle 200 forward to move the carriage assembly 14 to its stowed position, with the pull handle 200 being free to rotate into a comfortable or otherwise optimal angular orientation for the user. Once the carriage assembly 214 reaches its stowed position, the user can rotate the pull handle 200 so as to cause the latch 209 of the pull handle assembly 19 to engage the lock striker 226, thereby securing the pull handle 200 to the rear wall 306 of the fire engine 300, which in turn prevents the carriage assembly 14 from moving from its stowed position.

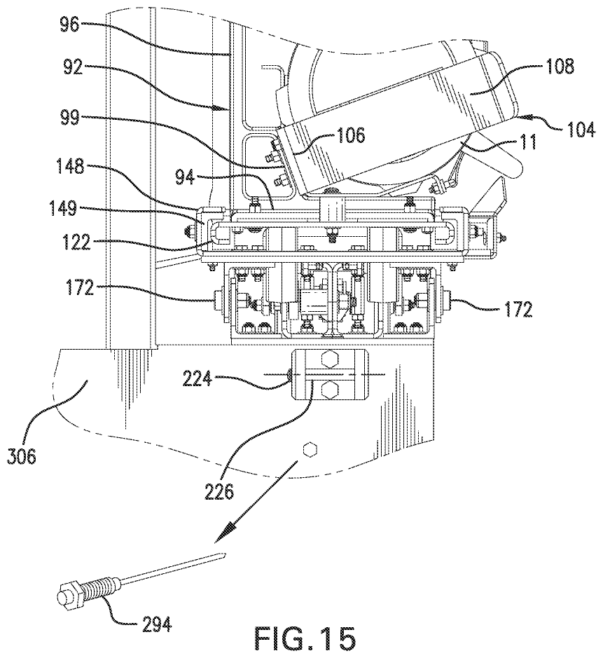

The pull handle assembly 19 can further include a sensor, such as a magnetic sensor 298 shown in FIGS. 15 and 24, configured to generate an output indicating that the latch 209 is positioned within the bracket 224 and is being securely held by the lock striker 226.

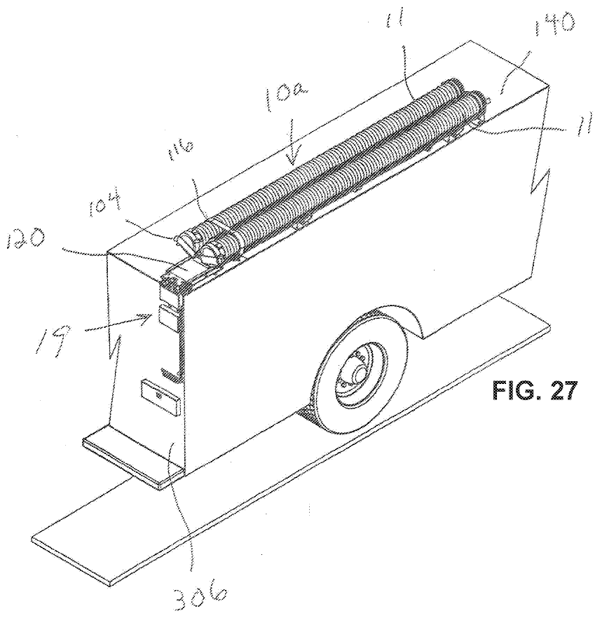

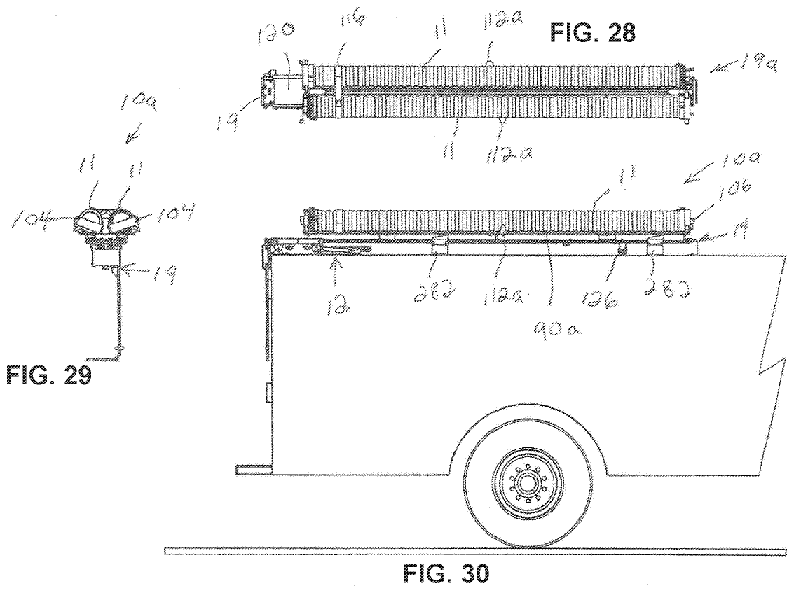

FIGS. 27-30 depict an alternative embodiment of the system 10 in the form of a system 10a. The system 10a is substantially identical to the system 10, with the following exception. The system 10a includes a tray assembly 18a in lieu of the tray assembly 18. The tray assembly 18a includes two trays 90a configured in a horizontal, or side by side arrangement so that the hard sleeves 11 are held in a side by side arrangement as depicted FIGS. 27-30. The tray assembly 18 includes two anti-roll brackets 112a each attached to a respective one of the trays 90a. Each anti-roll bracket 112a includes a lip that discourages the adjacent hard sleeve 11 from moving laterally, to help retain the hard sleeve 11 on its associated tray 90a.

In other alternative embodiments of the system 10, the tray assembly 18 can be modified or replaced by a structure that accommodates one or more ladders or other types of elongated items in lieu of the hard sleeves 11. For example, one or more mounts, retaining elements, and/or other structures that accommodate one or more ladders can be mounted on the shelf 120 of the carriage assembly 14 in lieu of the tray assembly 18, so that ladders can be stowed and retrieved in a manner similar to that described above in relation to the hard sleeves 11.

FIGS. 31-40 depict another alternative embodiment of the system 10 in the form of a system 10b. The system 10b is substantially similar to the system 10, with the following exceptions.

The system 10b is configured to hold an extension ladder 400. The system 10b also can be used to hold elongated objects other than ladders. The system 10b includes a base assembly 402, a carriage assembly 404, a forward support assembly 406, and a pull handle assembly 407. The base assembly 402 is substantially similar to the base assembly 12 of the system 10, and the above-noted description of the base assembly 12 applies equally to the base assembly 402 unless otherwise noted. The pull handle assembly 407 is substantially similar to the pull handle assembly 19 of the system 10, with the exception that a first portion 470 of a pull handle 472 of the pull handle assembly 407 is longer than the first portion 204 of the pull handle 200 of the pull handle assembly 19. The above-noted description of the pull handle assembly 19 applies equally to the pull handle assembly 407 unless otherwise noted.

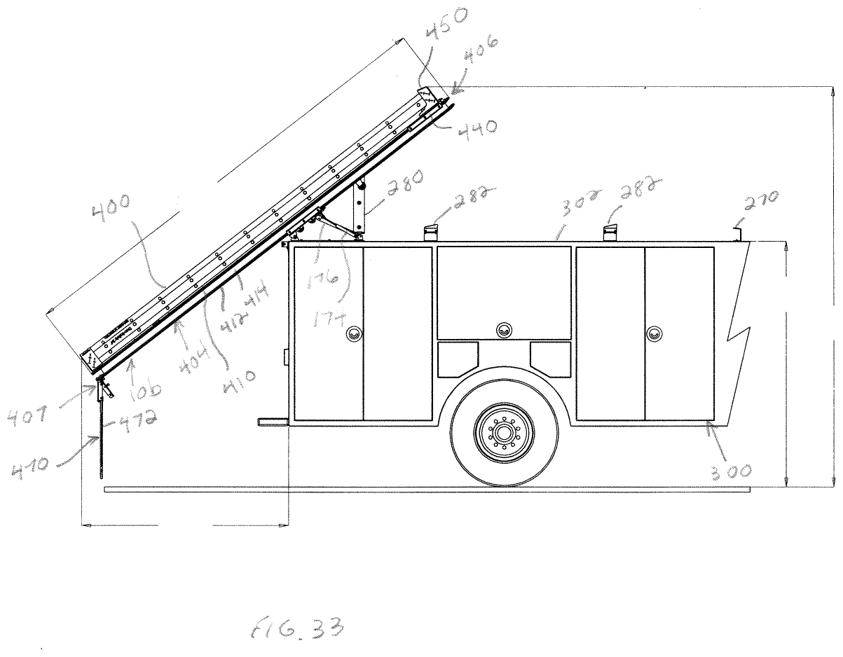

The forward support assembly 406 is mounted on the carriage assembly 404. The forward support assembly 406 can translate linearly in relation to the carriage assembly 404 between a forward position and a rearward position. The forward support assembly 406 is shown in its forward position in FIGS. 31-33, 35, 37, and 40. The forward support assembly 406 is shown in its rearward position in FIG. 34.

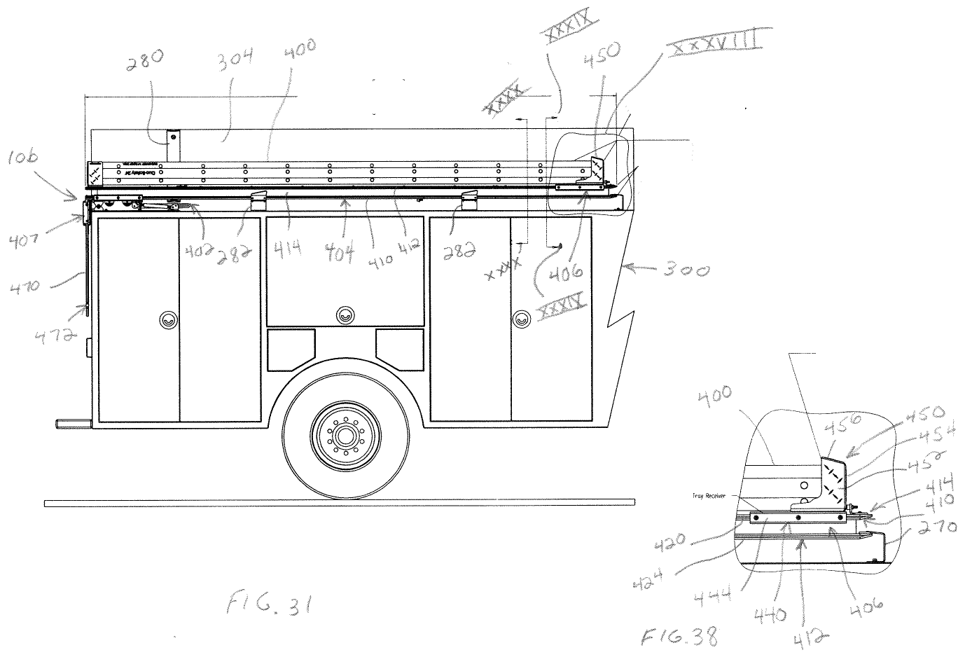

The carriage assembly 404 is mounted on the base assembly 402, and is configured to translate linearly in relation to the base assembly 402 (and the mounting surface 302) between a stowed position and a deployed position. The carriage assembly 404 is shown in its stowed position in FIGS. 31 and 35-40. The carriage assembly 404 is shown in its deployed position in FIGS. 32-34.

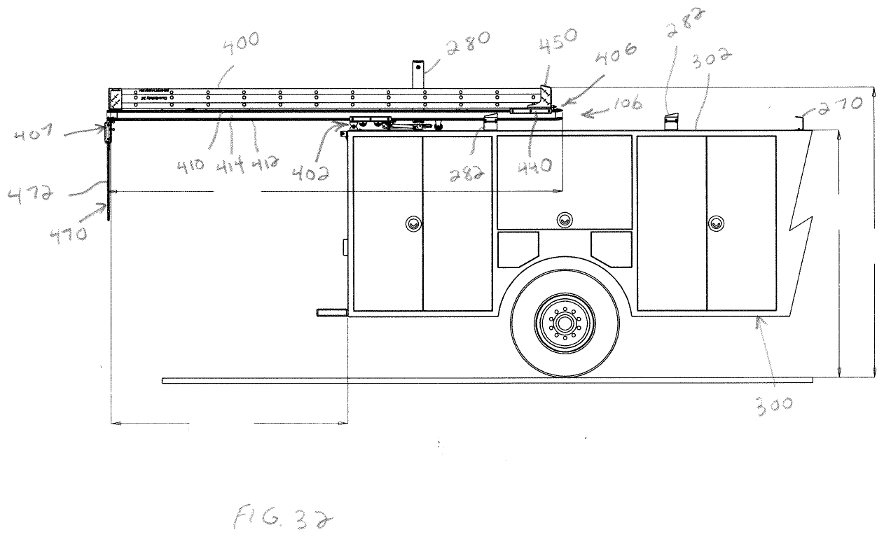

In addition, the carriage assembly 404 is configured to rotate between a horizontal or level orientation at which the carriage assembly 404 can be moved between its stowed and deployed positions; and a tilted orientation at which the ladder 400 can be accessed and removed from the system 10b by firefighters or other users on the ground, without the need for ladders, steps, or other provisions to elevate the users above the ground. The carriage assembly 404 is shown in its level orientation in FIGS. 32 and 35-40. The carriage assembly 404 is shown in its tilted orientation in FIGS. 33 and 34.

In some applications, the overall length of the carriage assembly 404 is greater than that of the carriage assembly 14 of the system 10 due to the relatively large overall length of extension ladders, such as the ladder 400, commonly used by firefighters.

Referring to FIGS. 31, 39, and 40, the carriage assembly 404 includes an upper shelf 410, a lower shelf 412, and two connecting members 414. The upper shelf 410 includes a substantially flat major portion 418, and two C-shaped lips 420 that adjoin and extend downward from opposite sides of the major portion 418. The lower shelf 412 includes a substantially flat major portion 422, and two C-shaped lips 424 that adjoin and extend downward from opposite sides of the major portion 422.

The upper shelf 410 is rigidly connected to the lower shelf 412 by the connecting members 414. The connecting members 414 are configured as C-channels. The connecting members 414 can have other configurations in alternative embodiments. A lower portion of each connecting member 414 is fixed to the major portion 422 of the lower shelf 412 by fasteners, welding, or other suitable means. An upper portion of each connecting member 414 is fixed to the major portion 418 of the upper shelf 410 by fasteners, welding, or other suitable means.

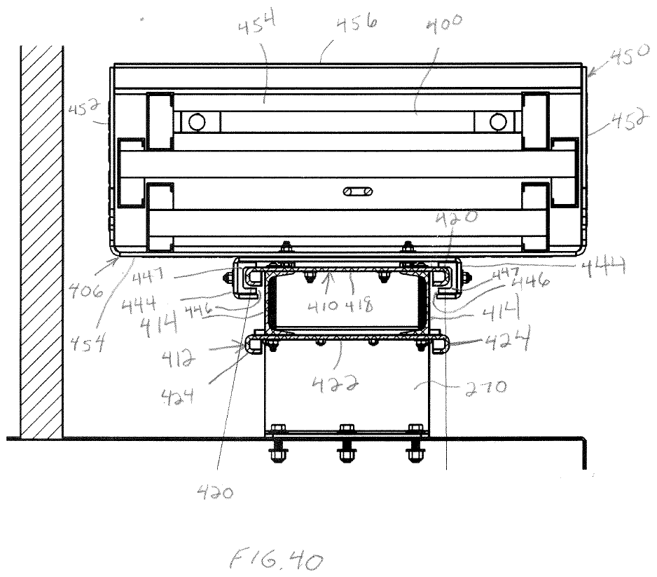

The lower shelf 412 engages the base assembly 402 as shown, for example, in FIG. 39. More specifically, the lips 424 of the lower shelf 412 are received in the respective guide portions 148 of the receiving member 144 of the base assembly 402 so that the base assembly 402 can support and guide the carriage assembly 404 as the carriage assembly 404 moves between its stowed and deployed positions, in a manner similar to that described above in relation to the carriage assembly 14 of the system 10.

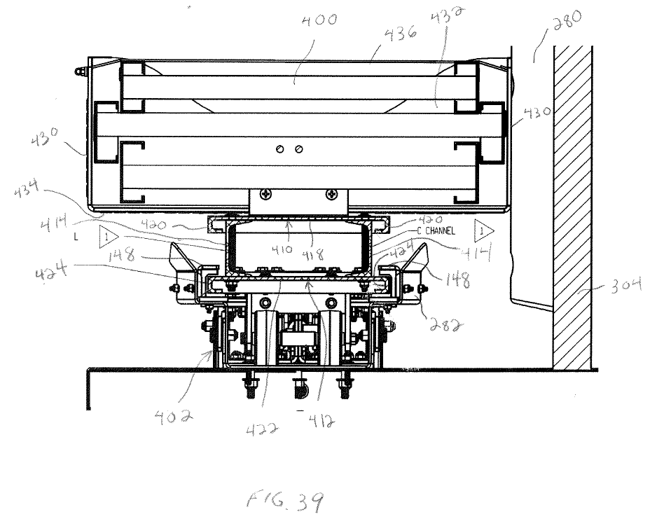

The system 10b also includes two of the shelf guides 282 as described above in relation to the system 10. The shelf guides 282 engage the lower shelf 412 and further support and guide the carriage assembly 404 as the carriage assembly 404 moves between its stowed and deployed positions and its level and tilted orientations. The system 10b further includes the anti-torque and stop bracket 270 as described above in relation to the system 10. The anti-torque and stop bracket 270 engages and restrains the forward end of the lower shelf 412 when the carriage assembly 404 is in its stowed position, as can be seen in FIG. 38.

The pull handle assembly 407 is fixed to a rearward end of the lower shelf 412 of the carriage assembly 404 as discussed above in relation to the pull handle assembly 19 and the carriage assembly 14 of the system 10.

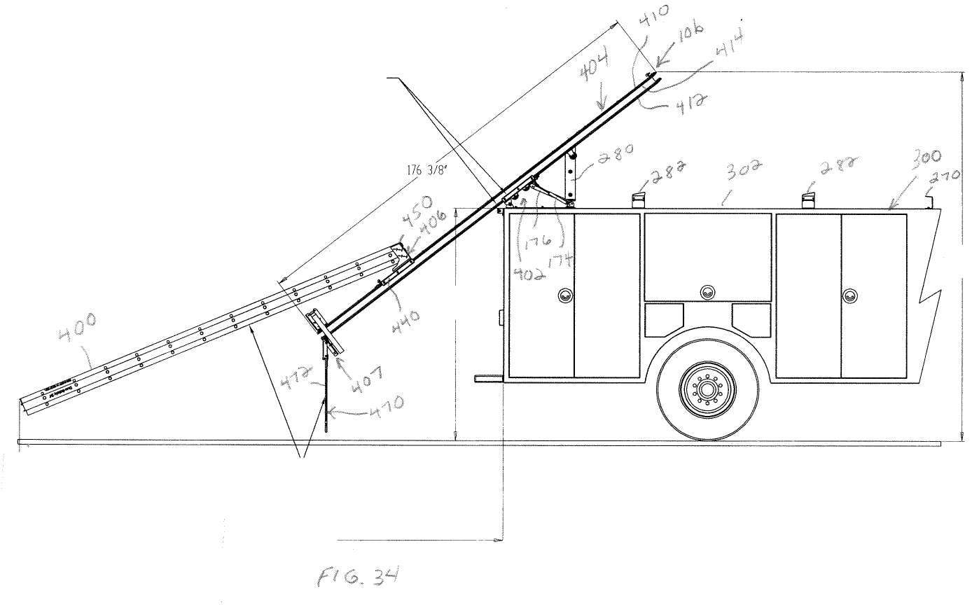

Referring to FIGS. 35 and 36, the carriage assembly 404 also includes an end cap 428. The end cap 428 is fixed to the rearward end of the major portion 418 of the upper shelf 410, and is configured to receive, support, and restrain the lower end of the ladder 400 when the ladder 400 is oriented with its upper end toward the front of the fire engine 300 (the end cap 428 can receive the upper end of the ladder 400 when the orientation of the ladder 400 in relation to the fire engine 300 is reversed.)

The end cap 428 includes two sidewalls 430, and a rear wall 432 that adjoins the sidewalls 430. The end cap 428 also includes a bottom portion 434 that adjoins the sidewalls 430 and the rear wall 432. The end cap 428 is secured to the major portion 418 of the upper shelf 410 by way of the bottom portion 434. The end cap 428 further includes a strap 436 that engages the sidewalls 430. The sidewalls 430, rear wall 432, and bottom portion 434 can be formed, for example, from steel diamond-plate sheet material or other suitable materials.

As noted above, the end cap 428 is configured to restrain the lower end of the ladder 400 from movement in relation to the carriage assembly 404. More specifically, the sidewalls 430 restrain the lower end of the ladder 400 from lateral movement, the strap 436 restrains the lower end from upward movement, and the rear wall 432 restrains the lower end from rearward movement. In addition, the rear wall 432 partially supports the ladder 400 when the carriage assembly 404 is in its tilted orientation.

The forward support assembly 406 receives, supports, and restrains the forward end of the ladder 400 and guides the forward end along the carriage assembly 404 as the forward support assembly 406 is moved to its rearward position in relation to the carriage assembly 404.

Referring to FIG. 40, the forward support assembly 406 includes a shelf 440. The shelf 440 has a substantially flat major portion 442, and two C-shaped lips 444 that adjoin and extend downward from opposite sides of the major portion 442.

The forward support assembly 406 engages the upper shelf 410 of the carriage assembly 404. More specifically, the lips 444 of the shelf 440 define respective channels 446. The lips 420 of the upper shelf 410 are received within the respective channels 446 so that the lips 420 guide the shelf 440 of the forward support assembly 406 and restrain the shelf 440 laterally as the forward support assembly 406 moves between its forward and rearward positions.

The forward support assembly 406 also includes two wear liners in the form of wear angles 447 that are positioned within the channels 446 and line the inward-facing surfaces of the respective lips 444 of the shelf 440. The wear angles 447 contact the lips 420 of the upper shelf 410 of the carriage assembly 404 and prevent direct contact between the lips 420 and the lips 444 of the shelf 440. The wear angles 447 are formed from plastic or another suitable material that results in relatively low friction between the wear angles 447 and the lips 420 of the upper shelf 410 as the lips 444 of the shelf 440 move over the lips 420 during movement of the forward support assembly 406 in relation to the carriage assembly 404.

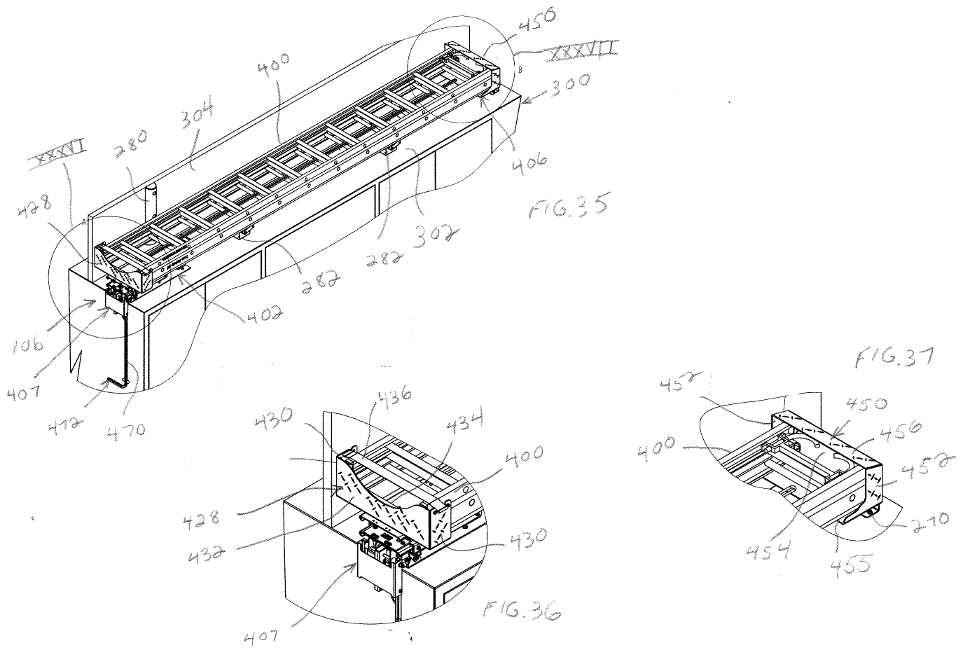

Referring to FIGS. 37 and 38, the forward support assembly 406 also includes an end cap 450. The end cap 450 is fixed to the forward end of the major portion 442 of the shelf 440 and is configured to receive, support, and restrain the upper end of the ladder 400. The end cap 450 includes two sidewalls 452, and a forward wall 454 that adjoins the sidewalls 452. The end cap 450 also includes a bottom portion 455 and a top portion 456 that each adjoin the sidewalls 452 and the forward wall 454. The end cap 450 is secured to the major portion 442 of the shelf 440 by way of the bottom portion 455. The end cap 450 can be formed, for example, from steel diamond-plate sheets or other suitable materials.

As noted above, the end cap 450 is configured to restrain the upper end of the ladder 400 from movement in relation to the forward support assembly 406. More specifically, the sidewalls 452 restrain the upper end of the ladder 400 from lateral movement, the top portion 456 restrains the upper end from upward movement, and the forward wall 454 restrains the upper end from forward movement.

A user or users can retrieve the ladder 400 from the fire engine 300 as follows. At the start of the retrieval process, the carriage assembly 406 is in its stowed position and its level orientation, and the forward support assembly 406 is in its forward position as depicted in FIGS. 31 and 35. As discussed above in relation to the pull handle assembly 19 of the system 10, the user(s), while standing on the ground behind the fire engine 300 (or other vehicle), grasp and manipulate the pull handle 472 of the pull handle assembly 407 to unlock the pull handle 472 and move the pull handle 472 to an angular orientation that is comfortable or otherwise optimal for the user(s) to exert a rearward force on the carriage assembly 404 to draw the carriage assembly 404 rearward, with the front support assembly 406 and the ladder 400 thereon, to its deployed position as depicted in FIG. 32. The forward support 406 moves with and remains stationary in relation to the carriage assembly 404, and the lower and upper ends of the ladder 400 remain with the respective end cap 428 and end cap 450 as the carriage assembly 404 moves between its stowed and deployed positions.

After the carriage assembly 404 reaches its deployed position as shown in FIG. 31, the user(s) pull the handle 472 downward to rotate the carriage assembly 404 to its tilted orientation as depicted in FIG. 33. The user(s) remove or otherwise disconnect the strap 436 of the end cap 428 once the carriage assembly 404 reaches its tilted orientation. One or more users lift the lower end of the ladder 400 upward and out of the end cap 428 while another user maintains downward force on the pull handle 472 so that the lower end of the ladder 400 comes out of the end cap 428. The users then walk the lower end of the ladder 400 rearward. As the lower end of the ladder 400 moves rearward, the shelf 440 of the forward support assembly 406 (and the attached end cap 450) moves linearly over the upper shelf 410 of the carriage assembly 404, with the wear angles 447 of the forward support assembly 406 sliding over the lips 420 of the upper shelf 410. Also, the upper end of the ladder 400 remains within the end cap 450 as the lower end of the ladder 400 moves rearward. Due to the angled orientation of the carriage assembly 404, the forward support assembly 406 and the upper end of the ladder 400 also move downward as the forward support assembly 406 translates rearward in relation to the carriage assembly 404 with the carriage assembly 404 in its tilted orientation.

As can be seen in FIG. 34, the rearward and downward movement of the ladder 400 eventually places the upper end of the ladder 400 at an elevation at which one or more of the users can grasp the ladder 400 at or near its upper end, allowing the user(s) to lift the upper end of the ladder out of the end cap 450 to complete the retrieval of the ladder from the system 10b.

To return and stow the ladder 400 on the fire engine 300, the user(s), while standing on the ground behind the fire engine 300 and with the carriage assembly 404 in its deployed position and tilted orientation, manually position the upper end of the ladder 400 in the end cap 450. The user(s) then urge the ladder 400 toward the forward end of the carriage assembly 404, which causes the upper end of the ladder 400 to push the end cap 450, and the remainder of the forward support 406, toward the forward end of carriage assembly 404, with the shelf 440 of the forward support assembly 406 translating linearly along the upper shelf 410 of the carriage assembly 414 as described above.

The continued movement of the upper end of the ladder 400 toward the forward end of the carriage assembly 404 eventually causes the forward support assembly 406 to reach its forward position, at which point the lower end of the ladder 400 aligns with the end cap 428. The user(s) then c lower the lower end of the ladder 400 into the end cap 428 and secure the lower end in place with the strap 436.

Once the ladder 400 is placed on and secured to the carriage assembly 404, the user(s) grasp the pull handle 472 of the pull handle assembly 407 and exert a force on the pull handle 472 that causes the carriage assembly 404 to rotate from its tilted orientation to its level orientation as depicting in FIG. 32. The user(s) then exert a force on the pull handle 472 that causes the carriage assembly 404, with ladder 400 and the forward support assembly 406 thereon, to move in the forward direction from its deployed position to its stowed position. Once the carriage assembly 404 reaches its stowed position, the user rotates the pull handle 472 to secure the pull handle 472 to the rear wall 306 of the fire engine 300, which in turn prevents the carriage assembly 404 from moving from its stowed position as discussed above in relation to the system 10.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described embodiments. Rather, the scope of the present solution should be defined in accordance with the following claims and their equivalents.

We claim:

1. A gantry system for stowing and deploying an elongated object, comprising:
a base assembly configured to be fixed to a mounting surface;
a carriage assembly including:
a first portion mounted on the base assembly and movable linearly in relation to the base assembly so that the carriage assembly can translate in relation to the first mounting surface between a stowed position and a deployed position, and
a second portion fixed to the first portion and configured to engage and retain a first portion of the elongated object; and
a forward support assembly configured to engage and retain a second portion of the elongated object, the forward support assembly mounted on the second portion of the carriage assembly and movable linearly in relation to the second portion of the carriage assembly between a forward position and a rearward position;
wherein the base assembly is configured to rotate the carriage assembly in the relation to the mounting surface between a substantially horizontal orientation and a tilted orientation.

2. The system of claim 1, wherein the forward support assembly includes:
a shelf engageable with the second portion of the carriage assembly so that the shelf is movable linearly in relation to the second portion of the carriage assembly; and
a first end cap mounted on the shelf and configured to receive and restrain the second portion of the elongated object.

3. The system of claim 2, wherein the first end cap is configured to receive and restrain the second portion of the elongated object while the carriage assembly moves between the stowed and deployed positions and the carriage assembly is in the substantially horizontal orientation.

4. The system of claim 3, wherein the first end cap is configured to receive and restrain the second portion of the elongated object while the forward support assembly moves between the forward and rearward positions and the carriage assembly is in the deployed position and the tilted orientation.

5. The system of claim 4, wherein:
the second portion of the carriage assembly includes an upper shelf, the upper shelf having a major portion and a lip that extends from the major portion;
the shelf of the forward support assembly includes a major portion and a lip that extends from the major portion of the shelf of the forward support; and
the lip of the upper shelf is engageable with the lip of the shelf of the forward support assembly to guide the forward support assembly between the forward and rearward positions of the forward support assembly.

6. The system of claim 5, wherein the carriage assembly further includes a second end cap mounted on the upper shelf and configured to receive and restrain the first portion of the elongated object while the carriage assembly moves between the stowed and deployed positions.

7. The system of claim 6, wherein the carriage assembly and the forward support assembly are configured to position the second end cap higher than the first end cap when the carriage assembly is in the deployed position and the tilted orientation and the forward support assembly is in the forward position.

8. The system of claim 7, wherein the carriage assembly and the forward support assembly are configured so that the second end cap lowers as the forward support assembly moves from the forward to the rearward position while the carriage assembly is in the deployed position and the tilted orientation.

9. The system of claim 1, wherein:
the first portion of the carriage assembly includes a lower shelf, the lower shelf having a major portion and a lip that extends from the major portion; and
the base assembly includes a guide engageable with the lip of the lower shelf to guide the carriage assembly between the stowed and deployed positions of the carriage assembly.

10. The system of claim 1, wherein:
the second portion of the carriage assembly is configured to engage and retain a first end of the elongated object; and
the forward support assembly is configured to engage and retain a second end of the elongated object.
